(19) United States
(12) Patent Application Publication
(10) Pub. No.: US 2012/0329515 A1
(43) Pub. Date: Dec. 27, 2012

(54) PER-PACKET RATE AND POWER CONTROL FOR WIRELESS COMMUNICATIONS

(75) Inventors: Paul J. HUSTED, San Jose, CA (US); Olaf J. Hirsch, Sunnyvale, CA (US)

(73) Assignee: QUALCOMM ATHEROS, INC., San Jose, CA (US)

(21) Appl. No.: 13/413,556

(22) Filed: Mar. 6, 2012

Related U.S. Application Data
(60) Provisional application No. 61/501,676, filed on Jun. 27, 2011.

(51) Int. Cl. H04W 88/02

(52) U.S. Cl. 455/552.1

(57) ABSTRACT

A method and device are disclosed for concurrently transmitting a Wi-Fi signal or a Bluetooth signal while receiving a cellular data signal. Upon receiving a request to receive a cellular data signal, the device determines a frequency for which the Wi-Fi signal and/or Bluetooth signal is or will be transmitted. The device then selectively transmits the Wi-Fi and/or Bluetooth signals at reduced power levels based, at least in part, on the frequencies at which the signals are transmitted, so that the Wi-Fi and/or Bluetooth signals can be transmitted without interfering with the cellular data signal being received concurrently.

### CROSS-REFERENCE TO RELATED APPLICATIONS

This application claims the benefit under 35 USC 119(e) of the co-pending and commonly owned U.S. Provisional Application No. 61/501,676 entitled “PER-PACKET RATE AND POWER CONTROL FOR WIRELESS COMMUNICATIONS” filed on Jun. 27, 2011, the entirety of which is incorporated herein by reference.

### TECHNICAL FIELD

The present embodiments relate generally to communication systems, and specifically to the concurrent reception of LTE signals and transmission of Wi-Fi or Bluetooth signals.

### BACKGROUND OF RELATED ART

Many wireless communication devices are capable of wireless communication with other devices using both wireless local area network (WLAN) signals and Bluetooth (BT) signals. For example, many laptops, netbook computers, and tablet devices use WLAN signals (also commonly referred to as Wi-Fi signals) to wirelessly connect to networks such as the Internet and/or private networks, and use Bluetooth signals to communicate with local BT-enabled devices such as headsets, printers, scanners, and the like. Wi-Fi communications are governed by the IEEE 802.11 family of standards, and Bluetooth communications are governed by the IEEE 802.15 family of standards. Wi-Fi and Bluetooth signals typically operate in the ISM band (e.g., 2.4-2.48 GHz). Many modern devices (such as cellular phones and tablet computers) are also capable of wireless communication using long term evolution (“LTE”) protocols, which operates in the range of 2.5 GHz.

As just noted, Wi-Fi and Bluetooth signals typically operate in the frequency range of 2.4-2.48 GHz, whereas LTE signals typically operate in one of a number of frequency bands, including 2.3 GHz and 2.5 GHz (e.g., depending in part upon the frequency selected by the local base station or tower). However, even though Wi-Fi and Bluetooth signals are typically transmitted on separate antennas than LTE signals, some amount of cross-channel interference is almost inevitable due to the limited separation between their operating frequencies. Specifically, the transmission of Wi-Fi and/or Bluetooth signals may interfere with the reception of LTE signals because the LTE antenna may undesirably pick up at least some of the Wi-Fi and/or Bluetooth signals broadcast by the Wi-Fi/Bluetooth antenna. Furthermore, due to the power and proximity at which LTE and Wi-Fi signals are communicated, analog methods of RF filtering have been inadequate at reducing the interference caused by the concurrent reception of LTE signals and transmission of Wi-Fi signals. As a result, many wireless devices are configured to either stop transmitting Wi-Fi/Bluetooth signals when receiving LTE signals, or to uniformly reduce the power of Wi-Fi/Bluetooth signals being transmitted when receiving LTE signals. However, such static power reduction schemes greatly reduce the performance of the wireless device.

Thus, there is a need to enable the concurrent reception of LTE signals and the transmission of Wi-Fi and/or Bluetooth signals in a manner that does not significantly reduce the performance of Wi-Fi and/or Bluetooth communications.

### BRIEF DESCRIPTION OF THE DRAWINGS

The present embodiments are illustrated by way of example and are not intended to be limited by the figures of the accompanying drawings, where:

FIG. 1 depicts wireless devices within which the present embodiments can be implemented;

FIG. 2 is a high-level block diagram of a wireless device capable of transmitting Wi-Fi and/or Bluetooth signals while concurrently receiving an LTE signal in accordance with some embodiments;

FIG. 3 is a block diagram of one embodiment of the wireless device of FIG. 2;

FIG. 4A is a graph depicting two Wi-Fi signals in the frequency domain relative to an LTE signal;

FIG. 4B is a graph depicting another Wi-Fi signal in the frequency domain relative to the LTE signal;

FIG. 5 is a graph depicting an exemplary power curve for selectively reducing the power level of a Wi-Fi and/or Bluetooth signal based on a frequency of the corresponding signal;

FIG. 6 is a more detailed block diagram of one embodiment of the control circuit of FIG. 3;

FIG. 7 is a flow chart depicting an exemplary operation of the wireless device of FIG. 3 when receiving an incoming LTE signal while transmitting Wi-Fi and/or Bluetooth signals; and

FIG. 8 is a flow chart depicting an exemplary operation of the wireless device of FIG. 3 when the device stops receiving an LTE signal while transmitting Wi-Fi and/or Bluetooth signals.

Like reference numerals refer to corresponding parts throughout the drawing figures.

### DETAILED DESCRIPTION

The present embodiments are discussed below in the context of selectively adjusting a transmission rate and/or power level of Wi-Fi and/or Bluetooth signals transmitted during reception of LTE signals for simplicity only. It is to be understood that the present embodiments are equally applicable for adjusting a transmission rate and/or power level of multiple signals of other various wireless standards or protocols to reduce cross-channel interference between the signals. In the following description, numerous specific details are set forth such as examples of specific components, circuits, software and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of myriad physical or logical mechanisms for communication between components.

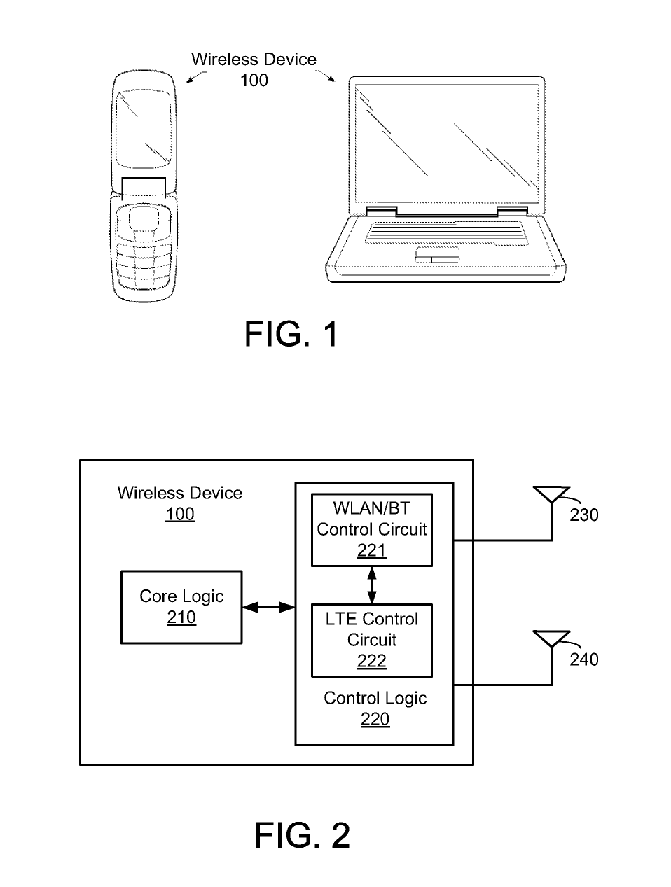

FIG. 1 shows wireless devices 100 such as a laptop and a cellular phone that can be configured to transmit Wi-Fi and/or Bluetooth signals and to receive LTE signals, concurrently, in accordance with some embodiments. Although not shown for simplicity, the wireless devices 100 can include other devices such as a tablet computer, a desktop computer, PDAs, and so on. For some embodiments, wireless devices 100 can use Wi-Fi signals to exchange data with the Internet, LAN, WLAN, and/or VPN, can use Bluetooth signals to exchange data with local BT-enabled devices such as headsets, printers, scanners, and so on, and can use LTE signals to implement cellular phone communications with other wireless communication devices.

FIG. 2 is a high-level functional block diagram of the wireless device 100 shown to include core logic 210, transceiver control logic 220, and two or more antennas 230 and 240. The core logic 210, which can include well-known elements such as processors and memory elements, performs general data generation and processing functions for the wireless device 100. The transceiver control logic 220 includes a WLAN/BT control circuit 221 and an LTE control circuit 222, and is coupled to core logic 210 and to the antennas 230 and 240. The WLAN/BT control circuit 221 is configured to control the transmission and reception of Wi-Fi and Bluetooth signals for device 100. The LTE control circuit 222 is configured to control the transmission and reception of LTE signals for device 100. The various components (not shown for simplicity) within core logic 210, WLAN/BT control circuit 221, and/or LTE control circuit 222 can be implemented in a variety of ways including, for example, using analog logic, digital logic, processors (e.g., CPUs, DSPs, microcontrollers, and so on), application specific integrated circuits (ASICs), field programmable gate arrays (FPGAs), or any combination of the above. Further, although shown in FIG. 2 as a single component, the WLAN/BT control circuit 221 can include separate or discrete control circuits (e.g., one dedicated for the transmission and reception of Wi-Fi signals, and the other dedicated for the transmission and reception of Bluetooth signals). In some embodiments, the WLAN/BT control circuit 221 and the LTE control circuit 222 can be implemented on the same integrated circuit (IC) chip. For other embodiments, the core logic 210, the WLAN/BT control circuit 221, and the LTE control circuit 222 can all be implemented on the same IC chip.

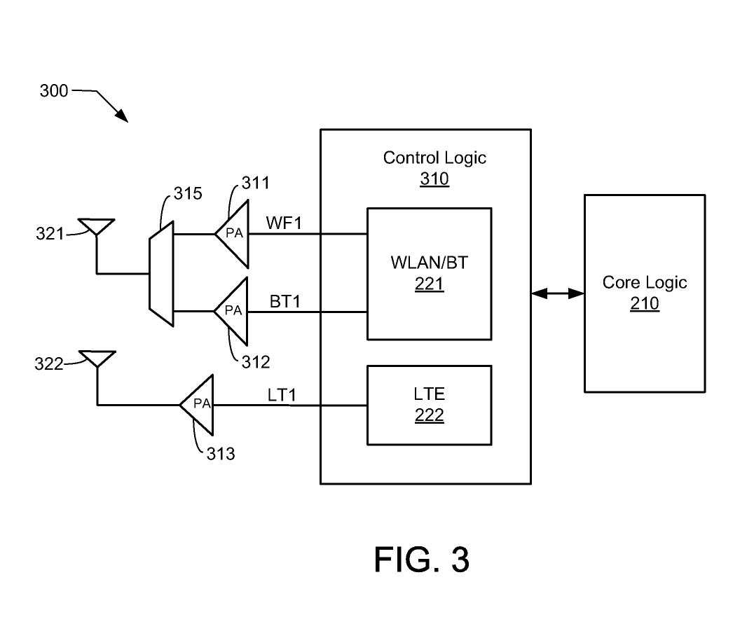

FIG. 3 shows a wireless device 300 that is one embodiment of device 100 of FIG. 2. The wireless device 300 includes transceiver control logic 310, a first power amplifier 311, a second power amplifier 312, a third power amplifier 313, signal combining logic 315, a first antenna 321, and a second antenna 322. The power amplifiers 311-313 and the antennas 321-322 are well-known. The transceiver control logic 310, which is one embodiment of transceiver control logic 220 of FIG. 2, is shown to include the WLAN/BT control circuit 221 and the LTE control circuit 222. Transceiver control logic 310 is also shown coupled to the core logic 210. The WLAN/BT control circuit 221 is coupled to the first and second power amplifiers 311 and 312, which in turn are coupled to the first antenna 321 via signal combining logic 315. The signal combining logic 315 is well-known, and can combine the Bluetooth signal BT1 and the Wi-Fi signal WF1 for broadcast by the first antenna 321. The LTE control circuit 222 is coupled to the third power amplifier 313, which in turn is coupled to the second antenna 322.

During normal transmission operations of device 300, the core logic 210 provides data for transmission according to the Wi-Fi and Bluetooth protocols to the WLAN/BT control circuit 221, and provides data for transmission according to the LTE protocol to the LTE control circuit 222. More specifically, in response to data received from the core logic 210, the WLAN/BT control circuit 221 generates a Wi-Fi signal (WF1) that is amplified by the first power amplifier 311 and subsequently broadcast by the first antenna 321 (e.g., according to well-known Wi-Fi protocols). The WLAN/BT control circuit 221 can also generate a Bluetooth signal (BT1) that is amplified by the second power amplifier 312 and subsequently broadcast by the first antenna 321 (e.g., according to well-known Bluetooth protocols). The LTE control circuit 222 generates an LTE signal (LT1) that is amplified by the third power amplifier 313 and subsequently broadcast by the second antenna 322 (e.g., according to well-known LTE protocols). In accordance with the present embodiments, device 300 is able to control the transmission rate and/or power level of Wi-Fi signals WF1 and Bluetooth signals BT1 broadcast by the first antenna 321 at selected frequencies while the second antenna 322 is receiving LTE signals LT1, as described in more detail below.

As discussed above, the Wi-Fi signals WF1 and Bluetooth signals BT1 are typically broadcast in the frequency range of 2.4-2.48 GHz (e.g., the ISM band), whereas LTE signals LT1 are broadcast in one of a number of frequency bands, including 2.3 GHz and 2.5 GHz. Specifically, in the United States, for example, the frequency spectrum is divided into 11 channels for the transmission of Wi-Fi signals WF1, up to 79 channels for the transmission of Bluetooth signals BT1, and currently 43 frequency bands for the transmission of LTE signals. Thus, while Wi-Fi/Bluetooth signals occupying higher channels (i.e., at the higher end of the ISM frequency spectrum) may cause significant interference with received LTE signals in the 2.5 GHz frequency band, Wi-Fi/Bluetooth signals occupying lower channels (i.e., at the lower end of the ISM frequency spectrum) may have a less pronounced or even a negligible effect on such received LTE signals. Conversely, while Wi-Fi/Bluetooth signals occupying lower channels (i.e., at the lower end of the ISM frequency spectrum) may cause significant interference with received LTE signals in the 2.3 GHz frequency band, Wi-Fi/Bluetooth signals occupying higher channels (i.e., at the higher end of the ISM frequency spectrum) may have a less pronounced or even a negligible effect on such received LTE signals. For one example, because LTE band number 40 ranges between 2.3 GHz and 2.4 GHz, Bluetooth signals broadcast in the lower ISM channels may cause the most interference with LTE band 40 signals. For another example, because LTE band number 7 ranges between 2.5 GHz and 2.57 GHz, Bluetooth signals broadcast in the higher ISM channels may cause the most interference with LTE band 7 signals. Further, it is noted that because the Bluetooth channel 7 uplink is near the top of the ISM band, the transmission of LTE band 7 signals may interfere with the reception of such Bluetooth signals.

Thus, for some embodiments, the transceiver control logic 310 determines when the second antenna 322 is receiving an LTE signal LT1 and selectively reduces the power level and/or transmission rate of the Wi-Fi signals and Bluetooth signals based on the frequency (or channel) at which they are to be transmitted. For example, Wi-Fi signals WF1 centered at the higher end of the frequency spectrum may have their power reduced significantly, whereas Wi-Fi signals WF1 centered at the lower end of the frequency spectrum may have their power reduced only slightly, or not at all (the same may apply for the Bluetooth signals BT1). In this manner, the device 300 is able to transmit Wi-Fi and/or Bluetooth signals via first antenna 321 more efficiently, without interfering with a concurrent reception of LTE signals via second antenna 322.

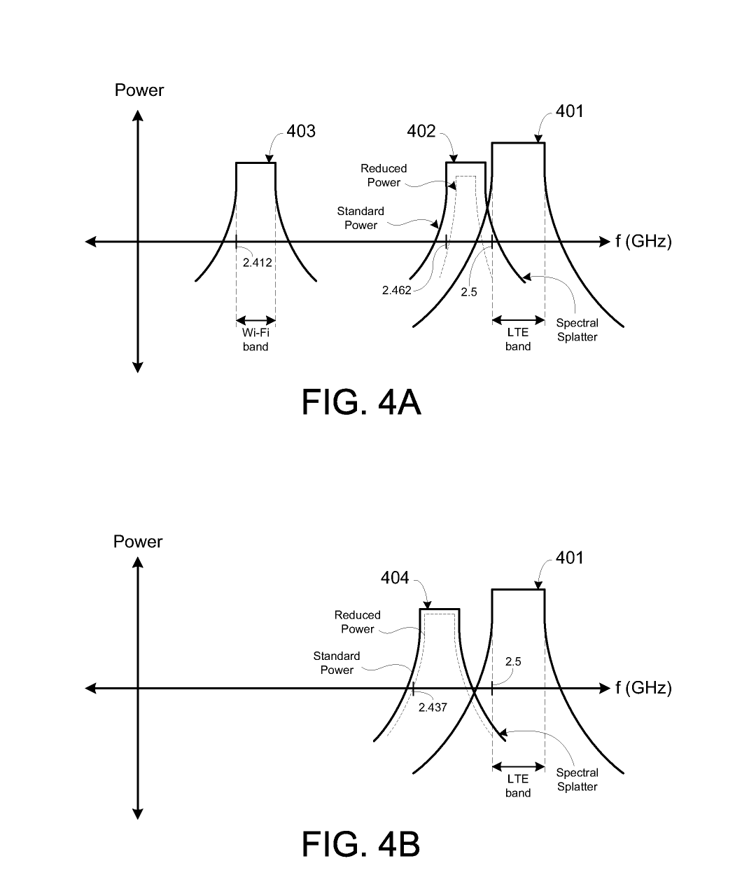

FIG. 4A is a graph depicting two Wi-Fi signals 402 and 403 in the frequency domain relative to an LTE signal 401. In the example shown, the LTE signal 401 is received at 2.5 GHz, while the first Wi-Fi signal 402 is broadcast at a base frequency of 2.462 GHz (e.g., Channel 11) and the second Wi-Fi signal 403 is broadcast at a base frequency of 2.412 GHz (e.g., Channel 1). Due to imperfect RF filtering, the actual bandwidth of the Wi-Fi signals 402 and 403 extends beyond the ideal Wi-Fi band, as allowed by regulatory agencies below a predetermined power spectral density level (the same holds true for the LTE signal 401). As a result, spectral splatter from the Wi-Fi signal 402 undesirably crosses into the LTE band, and causes interference with the received LTE signal 401. Note that because the frequency of the noise caused by Wi-Fi signal 402 falls inside the boundaries of the LTE band, analog RF filtering techniques for the LTE signal are not able to adequately filter out such spectral splatter. Thus, in accordance with the present embodiments, the power level and/or transmission rate of the Wi-Fi signal 402 can be reduced to a reduced power level for which the actual bandwidth of the Wi-Fi signal 402 does not cross the threshold of the LTE band, as depicted by the dotted waveform in FIG. 4A. In this manner, interference to the received LTE signal resulting from transmission of the Wi-Fi signal 402 can be effectively reduced (e.g., without using filter circuits). Note that, typically, the power of the Wi-Fi signal 402 directly affects its transmission rate. Thus, reducing the power of the Wi-Fi signal 402 lowers the maximum data rate of the Wi-Fi signal 402.

It should be noted that, while the first unaltered Wi-Fi signal 402 (i.e., with a base frequency of 2.462 GHz) causes interference with the received LTE signal 401, the second Wi-Fi signal 403 (i.e., with a base frequency of 2.412 GHz) has little to no effect on the received LTE signal 401. Accordingly, the Wi-Fi signal 403 can continue to be broadcast at the standard power level without interfering with reception of the LTE signal 401. In this manner, when device 300 receives or is about to receive an LTE signal LT1, the transceiver control logic 310 selectively controls or adjusts the power of an outgoing Wi-Fi signal WF1 based on its transmit frequency.

FIG. 4B is a graph depicting another Wi-Fi signal 404 in the frequency domain relative to the LTE signal 401. In the example shown, the LTE signal 401 is received at 2.5 GHz, while the Wi-Fi signal 404 is broadcast at a base frequency of 2.437 GHz (e.g., channel 6). Note that the standard power of Wi-Fi signal 404 at this frequency creates less interference with the received LTE signal 401 than the standard power Wi-Fi signal 402 shown in FIG. 4A, which was broadcast at a slightly higher frequency. Thus, the Wi-Fi signal 404 can have a smaller reduction in power than the Wi-Fi signal 402 and still maintain acceptable isolation from the LTE band.

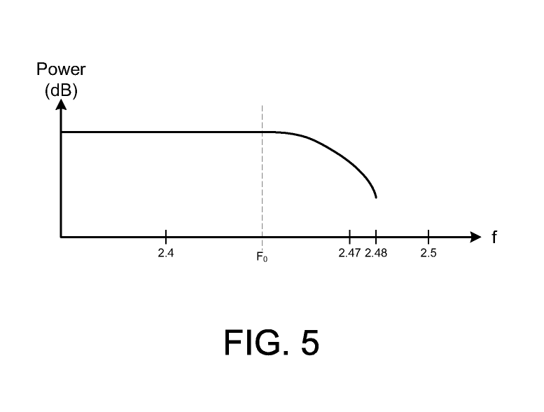

It should also be noted that, as the power is reduced, the frequency profile of each of the Wi-Fi signals 402 and 404 also tapers (e.g., the out-of-band noise is exponentially reduced as the output power shrinks), as depicted in FIGS. 4A and 4B, respectively. Thus, the power profile for the Wi-Fi signals WF1 output by the wireless device 300, while the device 300 is receiving LTE signals LT1, is a non-linear function with respect to the frequency at which the Wi-Fi signals WF1 are transmitted, as shown and described below in FIG. 5.

Further, while the foregoing embodiments have been described above with respect to Wi-Fi signals WF1, the same techniques can be applied for reducing the output power and/or transmission rate of Bluetooth signals BT1. Additional embodiments may take advantage of Bluetooth technology's adaptive frequency-hopping (AFH) techniques to not only control the power at which Bluetooth signals BT1 are transmitted, but also the individual frequencies at which each Bluetooth signal BT1 is broadcast. For example, referring now to FIG. 5, F₀ denotes the maximum or minimum frequency at which no reduction in output power is needed to concurrently transmit a Wi-Fi or Bluetooth signal while receiving an LTE signal having a broadcast frequency higher or lower, respectively, than the ISM band. Thus, in some embodiments, the transceiver control logic 310 can limit the frequency-hopping spectrum for the Bluetooth signals BT1 to be between 2.402 GHz and F₀ when the LTE frequency is greater than the ISM band, and can limit the frequency-hopping spectrum for the Bluetooth signals BT1 to be between F₀ and 2.480 GHz when the LTE frequency is less than the ISM band.

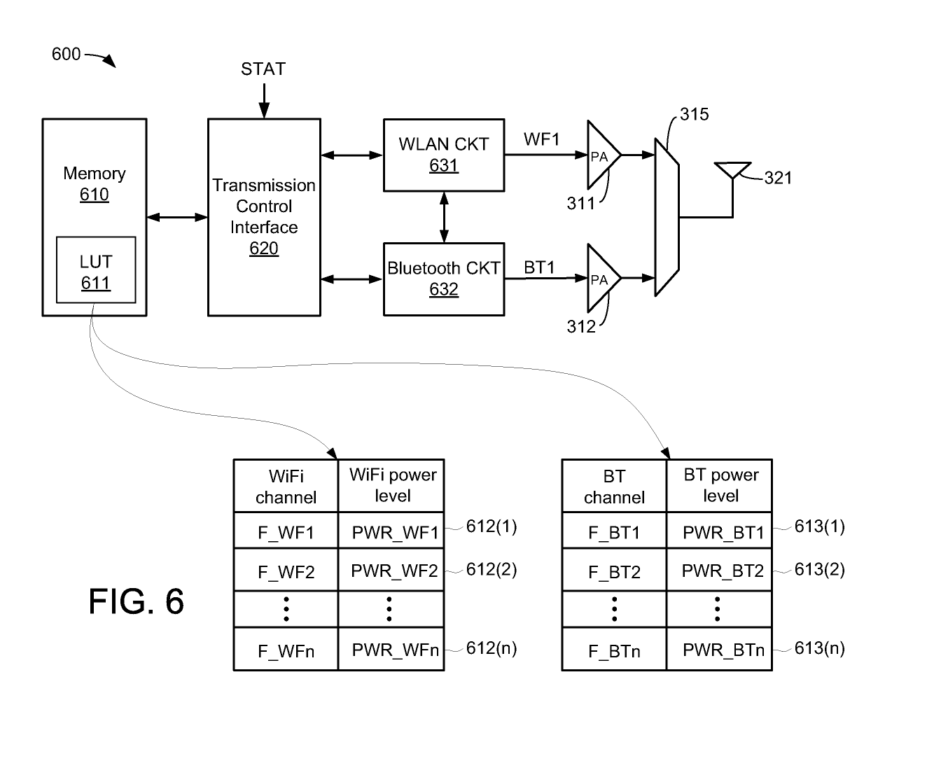

FIG. 6 is a block diagram of a portion of control logic 600 that is one embodiment of control logic 310 of FIG. 3. Control logic 600 is shown to include a memory 610 and a transmission control interface 620, as well as a WLAN control circuit 631 and Bluetooth control circuit 632. Together, WLAN control circuit 631 and Bluetooth control circuit 632 form one embodiment of control circuit 221 of FIG. 2. The memory 610 is coupled to control interface 620, which in turn is coupled to the WLAN control circuit 631 and the Bluetooth control circuit 632. The WLAN control circuit 631 and the Bluetooth control circuit 632 are each coupled to respective power amplifiers 311 and 312, which in turn are coupled to antenna 321 via signal combining logic 315. For simplicity, the LTE control circuit 222, the third power amplifier 313, and the second antenna 322 of wireless device 300 are not shown in FIG. 6.

For exemplary embodiments described herein, the memory 610 includes a look-up table 611 that can be implemented using well-known storage elements including, for example, latches, registers, SRAM, DRAM, EEPROM, flash memory, and so on. For some embodiments, the look-up table 611 can be formed using content addressable memory (CAM) cells. The look-up table 611 includes a plurality of first storage locations 612 and a plurality of second storage locations 613. Each storage location 612 of look-up table 611 stores a Wi-Fi channel F_WF and an associated Wi-Fi power level PWR_WF for the Wi-Fi signals to be processed by the first power amplifier 311. Similarly, each storage location 613 of look-up table 611 stores a Bluetooth channel F_BT and an associated Bluetooth power level PWR_BT for the Bluetooth signals to be processed by the second power amplifier 312. For example, storage location 612(1) stores a first Wi-Fi frequency F_WF1 and a corresponding Wi-Fi power level PWR_WF1, storage location 612(2) stores a second Wi-Fi frequency F_WF2 and a corresponding Wi-Fi power level PWR_WF2, and so on. More specifically, for each value of F_WF, which indicates the channel or frequency of a Wi-Fi signal being transmitted or scheduled to be transmitted, the corresponding value of PWR_WF indicates the maximum allowable power that an associated Wi-Fi signal processed by the first power amplifier 311 can have without interfering with an LTE signal being concurrently received via second antenna 322 (see also FIG. 3). Note that the same technique applies for the Bluetooth channels F_BT and associated Bluetooth power levels PWR_BT. The maximum power levels embodied by the values PWR_BT and PWR_WF can be predetermined based on signal-to-noise ratios (SNR) of received LTE test packets or, alternatively, measured dynamically by one or more processors (not shown for simplicity) embedded within wireless device 300. Other factors that can influence the maximum power levels of PWR_BT and PWR_WF for corresponding transmit frequencies may include the operating characteristics of power amplifiers 311 and/or 312, and/or other factors such as the desired range of Wi-Fi and Bluetooth signals transmitted from the antenna 321.

The transmission control interface 620 uses the Wi-Fi and Bluetooth channel data and associated maximum power level values stored in the look-up table 611 to selectively adjust operation of the WLAN control circuit 631 and/or the Bluetooth control circuit 632 to ensure that transmission of WLAN and Bluetooth signals (e.g., signals WF2 and BT1) through first antenna 321 does not interfere with a concurrent reception of LTE signals via second antenna 322. The transmission control interface 620 can be implemented as hardwired logic, as software executable by a processor, or as a combination of hardware and software.

For some embodiments, the transmission control interface 620 receives from the LTE control circuit (not shown) a message or status signal (STAT) indicating whether an LTE signal is currently being (or about to be) received, information indicating the transmission power level of the LTE signal, and/or scheduling information indicating if and when additional LTE signals are subsequently scheduled for reception by the wireless device. For some embodiments, the scheduling information for the LTE control circuit can be stored in memory 610. For other embodiments, the scheduling information for the LTE control circuit can be stored in another memory (e.g., provided within and/or associated with transmission control interface 620).

More specifically, when an LTE signal is being received or is about to be received by the device 300, the transmission control interface 620 determines the frequency at which a Wi-Fi signal or Bluetooth signal is being transmitted, retrieves the corresponding maximum allowable Wi-Fi or Bluetooth power level from the look-up table 611 (e.g., using the Wi-Fi transmit frequency as a look-up value), and then adjusts the power of the Wi-Fi and/or Bluetooth signals accordingly so that the transmit power of the Wi-Fi and/or Bluetooth signal does not exceed the maximum allowable Wi-Fi or Bluetooth power level. In this manner, the transmission control interface 620 is able to adjust the power output levels of Wi-Fi and/or Bluetooth signals on a per-packet basis, so that Wi-Fi and Bluetooth signals can be transmitted in the most efficient manner without interfering with a concurrent reception of LTE signals. For some embodiments, the transmission control interface 620 may also determine a limited frequency spectrum within which Bluetooth frequency hopping can take place (e.g., <F₀).

As mentioned above, the transmission control interface 620 can be configured to adjust the power level of the Wi-Fi signal to be transmitted via first antenna 321 in response to the LTE scheduling information and/or the frequency of the W-Fi signal. More specifically, for some embodiments, the transmission control interface 620 can be configured to determine a power offset or back-off level (PWR_{OFFSET}) that can be applied to reduce the transmission power of the Wi-Fi signal (e.g., by dynamically adjusting the gain of the first power amplifier 311) to ensure that the transmission of the Wi-Fi signal via first antenna 321 does not interfere with a concurrent reception of an LTE signal via second antenna 322. Similarly, the control interface 620 can also determine a power offset or back-off level that can be used to reduce the transmission power of a Bluetooth signal (e.g., by dynamically adjusting the gain of the second power amplifier 312) to ensure that the transmission of the Bluetooth signal does not interfere with a concurrent reception of an LTE signal.

For some embodiments, the transmission control interface 620 subtracts the maximum allowable Wi-Fi power level from the current Wi-Fi transmit power level to determine the Wi-Fi back-off level (PWR_{OFFSET}), and then selectively reduces the Wi-Fi transmit power level by the Wi-Fi back-off level (PWR_{OFFSET}) to achieve the reduced Wi-Fi transmit power level. If the value of PWR_{OFFSET} is negative (e.g., indicating that the maximum allowable Wi-Fi power level is greater than the current Wi-Fi transmit power level, then no power adjustment is performed. For other embodiments, the transmission control interface 620 can reduce the Wi-Fi transmit power level to the maximum allowable Wi-Fi power level for the corresponding Wi-Fi transmit frequency (e.g., without calculating the Wi-Fi back-off level). Further, for some embodiments, the transmission control interface 620 can compare the reduced Wi-Fi transmit power level with a predetermined Wi-Fi power threshold value (THR_{WF}) to determine whether to continue the transmission of the Wi-Fi signal via first antenna 321 while LTE signals are being received via second antenna 322, or to terminate transmission of the Wi-Fi signal until the LTE signals are no longer being received at second antenna 322. The predetermined threshold value THR_{WF} is indicative of the minimum acceptable power level of the Wi-Fi signals to be transmitted. Thus, if the reduced Wi-Fi transmit power level is greater than the Wi-Fi power threshold value THR_{WF}, then the Wi-Fi signal can be transmitted at the reduced power level and still have enough transmission energy to be received by another wireless device. Otherwise, if the reduced Wi-Fi transmit power level is less than THR_{WF}, the Wi-Fi signal would not have sufficient power to be properly received by the other wireless device, and is therefore delayed or terminated.

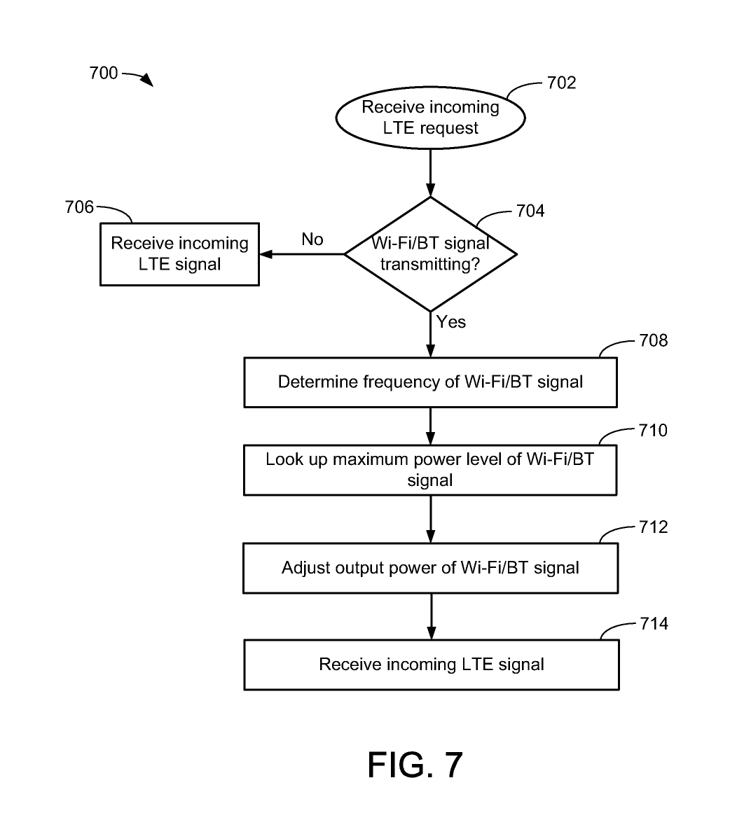

FIG. 7 is a flow chart 700 depicting an exemplary operation of wireless device 300 when receiving an incoming LTE signal while already transmitting Wi-Fi and/or Bluetooth signals. At 702, the transmission control interface 620 receives a request and/or a transmission schedule indicating an expected reception of incoming LTE data packets (e.g., from the LTE control circuit 222) via second antenna 322. In response thereto, the transmission control interface 620 determines whether a Wi-Fi and/or Bluetooth signal is currently being transmitted by the antenna 321, at 704. If no Wi-Fi or Bluetooth signals are currently being transmitted via first antenna 321, the device 300 simply proceeds to receive the incoming LTE signal via second antenna 322, at 706. Conversely, if first antenna 321 is currently transmitting a Wi-Fi and/or Bluetooth signal (or if, during reception of the LTE request, a Wi-Fi or Bluetooth signal is scheduled to be transmitted), then the transmission control interface 620 determines the transmit frequency of the Wi-Fi or Bluetooth signal being transmitted, at 708. Next, the transmission control interface 620 retrieves a corresponding maximum allowed Wi-Fi or Bluetooth power level from the look-up table 611 (e.g., using the signal's frequency channel as a look-up value for selecting an entry from look-up table 611), at 710. For some embodiments, the transmission control interface 620 may also look up a limited frequency band within which Bluetooth frequency hops may be scheduled to occur. Then, at 712, the transmission control interface 620 selectively adjusts the output power level of the Wi-Fi or Bluetooth signal (e.g., by adjusting a power offset applied to the power amplifiers 311-312) based on the maximum power level specified for the corresponding channel, so that the device 300 can receive the incoming LTE signal without interference from the transmitted Wi-Fi and/or Bluetooth signals, at 714. Note, however, that transmitting Wi-Fi and/or Bluetooth signals according to this reduced power scheme may not necessarily result in an actual reduction in the power level of a particular Wi-Fi or Bluetooth packet, depending on the frequency at which it is transmitted (as discussed above). Further, although the transmit power of Wi-Fi and Bluetooth data may not be changed mid-packet, the present embodiments may determine if there is soon going to be reception of LTE signals prior to transmitting subsequent Wi-Fi and/or Bluetooth data, and then adjust the transmit power of the Wi-Fi and/or Bluetooth data accordingly.

For some embodiments, the control interface 620 may also determine the receive frequency of the LTE signals, and then compare the transmit frequency of the Wi-Fi or Bluetooth signal with the receive frequency of the LTE signals to generate a difference value. If the difference value is greater than or equal to a predetermined threshold value, which may indicate that the received LTE signal will have a negligible effect upon the transmitted Wi-Fi or Bluetooth signal (e.g., because of adequate channel separation), then the power level of the Wi-Fi or Bluetooth signal is not reduced. Conversely, if the difference value is less than the predetermined threshold value, which may indicate that the received LTE signal will have an unacceptable effect upon the transmitted Wi-Fi or Bluetooth signal (e.g., because of inadequate channel separation), then the power level of the Wi-Fi or Bluetooth signal is reduced in response to the retrieved maximum allowed power level.

For other embodiments, control interface 620 may first determine whether device 300 is to begin receiving LTE signals prior to the end of the Wi-Fi or Bluetooth data frame, and then selectively reduce the transmit power level of the Wi-Fi or Bluetooth data frame. More specifically, if device 300 is to begin receiving LTE signals prior to the end of the Wi-Fi or Bluetooth data frame, then the Wi-Fi or Bluetooth data frames are transmitted at a reduced power level. Conversely, if device 300 is not to begin receiving LTE signals prior to the end of the Wi-Fi or Bluetooth data frame, then the Wi-Fi or Bluetooth data frames are transmitted at a normal (e.g., full) power level.

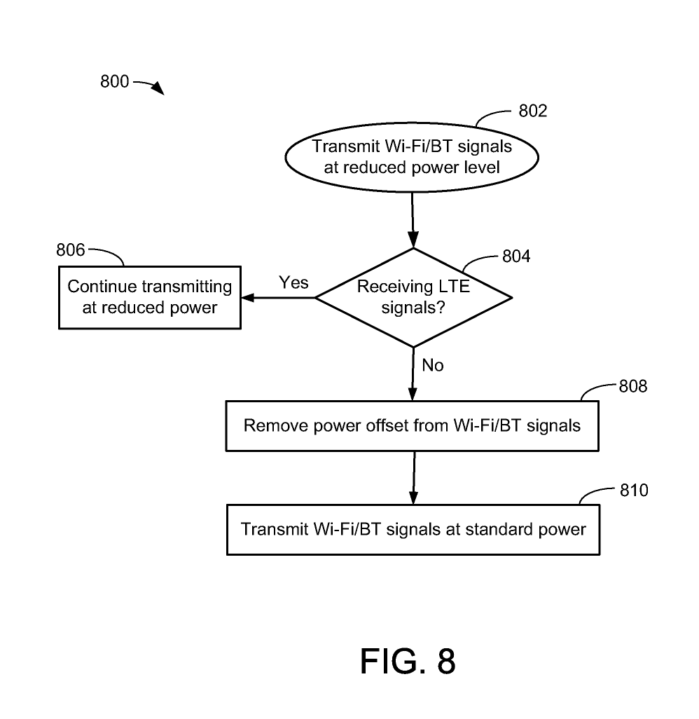

FIG. 8 is a flow chart 800 depicting an exemplary operation of wireless device 300 for when the device stops receiving an LTE signal while transmitting Wi-Fi and/or Bluetooth signals. At 802, the wireless device 300 is transmitting Wi-Fi and/or Bluetooth signals at selectively reduced power levels while concurrently receiving an incoming LTE signal. At 804, the transmission control interface 620 determines whether an LTE signal is still being received by the device 300 (e.g., as indicated by the LTE control circuit 222). If incoming LTE packets are still being received, the device 300 continues transmitting the Wi-Fi and/or Bluetooth signals according to the reduced power level scheme, at 806. Note that merely transmitting Wi-Fi and/or Bluetooth signals according to the reduced power scheme may not necessarily result in an actual reduction in the power level of a particular Wi-Fi or Bluetooth packet, depending on the frequency at which it is transmitted (as discussed above).

However, if the device 300 has stopped receiving LTE signals, the transmission control interface 620 removes the power offset applied to the Wi-Fi and Bluetooth signals currently being transmitted (e.g., through respective power amplifiers 311 and 312), at 808, so that the Wi-Fi and/or Bluetooth signals can once again be transmitted at standard power, at 810. In some embodiments, the transmission control interface 620 may also remove any limitations placed on the frequency spectrum within which Bluetooth frequency hopping can take place. In this manner, Wi-Fi and Bluetooth signals can immediately be brought back up to normal operating power levels as soon as the device 300 stops receiving LTE signals, thus maximizing the efficiency at which Wi-Fi and/or Bluetooth signals can be transmitted when concurrently receiving an LTE signal.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. For example, while the embodiments above were described specifically in the context of receiving LTE signals, the selective power adjustment methods may be equally applied for the transmission of Wi-Fi and/or Bluetooth signals while concurrently receiving any type of cellular communications protocol (e.g., EDGE, UMTS, WiMax, etc.).

What is claimed is:

1. A method for concurrently transmitting a first signal via a first antenna in a wireless communication device while receiving a second signal via a second antenna in the device, the method comprising:
receiving an indication that the device is about to receive the second signal;
determining a transmit frequency of the first signal and a receive frequency of the second signal;
comparing the frequencies of the first and second signals to generate a difference value;
retrieving, from a look-up table, a maximum allowed power level associated with the transmit frequency of the first signal; and
selectively reducing an output power level of the first signal in response to the retrieved maximum allowed power level if the difference value is less than a predetermined threshold value.

2. The method of claim 1, wherein the first signal comprises either a Wi-Fi signal or a Bluetooth signal, and the second signal comprises a cellular signal.

3. The method of claim 1, wherein the selectively reducing comprises:
selectively adjusting a gain of a power amplifier associated with the transmission of the first signal so that the transmit power of the first signal does not exceed the maximum allowed power level.

4. The method of claim 1, wherein the output power level of the first signal is reduced to a reduced power level that maintains an energy level of spectral splatter of the first signal falling within a bandwidth of the second signal below a predetermined level.

5. The method of claim 4, further comprising:
receiving the second signal via the second antenna while transmitting the first signal via the first antenna at the reduced power level.

6. The method of claim 4, wherein the selectively reducing further comprises:
if the reduced power level is less than a predetermined level, terminating transmission of the first signal.

7. The method of claim 1, wherein the selectively reducing comprises:
calculating a back-off power level by subtracting the maximum allowed power level from a current transmission power level; and
reducing the current transmission power level by the back-off power level to achieve a reduced transmission power level.

8. The method of claim 1, further comprising:
receiving scheduling information associated with reception of the second signal; and
selectively restoring the output power level of the first signal in response to the scheduling information.

9. A wireless communication device to concurrently transmit a first signal via a first antenna while receiving a second signal via a second antenna, the device comprising:
means for receiving an indication that the device is about to receive the second signal;
means for determining a transmit frequency of the first signal and a receive frequency of the second signal;
means for comparing the frequencies of the first and second signals to generate a difference value;
means for retrieving a maximum allowed power level associated with the transmit frequency; and
means for selectively reducing an output power level of the first signal in response to the retrieved maximum allowed power level if the difference value is less than a predetermined threshold value.

10. The device of claim 9, wherein the first signal comprises either a Wi-Fi signal or a Bluetooth signal, and the second signal comprises a cellular signal.

11. The device of claim 9, wherein the means for selectively reducing comprises:
means for selectively adjusting a gain of a power amplifier associated with the transmission of the first signal so that the transmit power of the first signal does not exceed the maximum allowed power level.

12. The device of claim 9, wherein the output power level of the first signal is reduced to a reduced power level that maintains an energy level of spectral splatter of the first signal falling within a bandwidth of the second signal below of predetermined level.

13. The device of claim 12, further comprising:
means for receiving the second signal via the second antenna while transmitting the first signal via the first antenna at the reduced power level.

14. The device of claim 12, wherein the means for selectively reducing further comprises:
means for terminating transmission of the first signal if the reduced power level is less than a predetermined level.

15. The device of claim 9, wherein the means for selectively reducing comprises:
means for calculating a back-off power level by subtracting the maximum allowed power level from a current transmission power level; and
means for reducing the current transmission power level by the back-off power level to achieve a reduced transmission power level.

16. The device of claim 9, further comprising:
means for receiving scheduling information associated with reception of the second signal; and
means for selectively restoring the output power level of the first signal in response to the scheduling information.

17. A wireless communication device, comprising:
a first antenna to transmit a Wi-Fi signal;
a second antenna to receive a cellular data signal;
a memory having a plurality of storage locations, each for storing a maximum allowed power level of the Wi-Fi signal for a corresponding transmit frequency of the Wi-Fi signal; and
a control interface, coupled to the memory, to selectively reduce a transmit power level of the Wi-Fi signal to a selected one of the maximum allowed power levels when the cellular data signal is to be received by the second antenna.

18. The device of claim 17, wherein the reduced transmit power level of the Wi-Fi signal maintains a spectral splatter of the Wi-Fi signal substantially outside of a bandwidth of the cellular data signal.

19. The device of claim 17, wherein the selected maximum allowed power level is retrieved from the memory in response to a transmit frequency of the Wi-Fi signal.

20. The device of claim 17, further comprising:
a power amplifier having an input to receive the Wi-Fi signal and having an output coupled to the first antenna, wherein the transmit power level of the Wi-Fi signal is reduced by adjusting a gain of the power amplifier.

21. The device of claim 20, wherein the control interface is further configured to calculate a Wi-Fi back-off power level by subtracting the selected maximum allowed Wi-Fi power level from a current Wi-Fi transmission power level, and wherein the gain of the power amplifier is reduced according to the Wi-Fi back-off power level.

22. The device of claim 17, wherein the control interface is to terminate transmission of the Wi-Fi signal if the reduced transmit power level of the Wi-Fi signal is less than a predetermined value.
